(19) United States
(12) Patent Application Publication
(10) Pub. No.: US 2009/0078773 A1
(43) Pub. Date: Mar. 26, 2009

(54) Multiple Configuration Image Scanner

(75) Inventors: Bradley S. Carlson, Huntington, NY (US); Duanfeng He, South Setauket, NY (US)

Correspondence Address: Tarolli, Sundheim, Covell & Tummino L.L.P, 1300 East Ninth Street, Suite 1700, Cleveland, OH, 44114, US

(73) Assignee: Symbol Technologies, Inc., Holtsville, NY (US)

(21) Appl. No.: 11/858,417

(22) Filed: Sep. 20, 2007

(51) Int. Cl. G06K 7/10

(52) U.S. Cl. 235/462.24; 235/462.15

(57) ABSTRACT

An imaging-based bar code reader that includes an imaging and decoding system. Focusing optics and a sensor array define a field of view. An exemplary system has an image sensor includes multiple configuration registers. With multiple configuration registers a video mode can be implemented where the video consists of a continuous sequence of frames with a fixed sequence a number of configurations. The configurations can vary the frame size, exposure time, gain, etc. Compared to a sensor with only one set of configuration registers, successive frames can be captured with different configurations without synchronization issues or frame lag.

### FIELD OF THE INVENTION

The present invention relates to an imaging-based bar code reader and, more particularly, to a bar code reader that facilitates capturing images.

### BACKGROUND OF THE INVENTION

Various electro-optical systems have been developed for reading optical indicia, such as bar codes. A bar code is a coded pattern of graphical indicia comprised of a series of bars and spaces having differing light reflecting characteristics. The pattern of the bars and spaces encode information. In certain bar codes, there is a single row of bars and spaces, typically of varying widths. Such bar codes are referred to as one dimensional (1D) bar codes. Other bar codes include multiple rows of bars and spaces, each row typically having the same width. Such bar codes are referred to as two dimensional (2D) bar codes.

Imaging systems include charge coupled device (CCD) arrays, complementary metal oxide semiconductor (CMOS) arrays, or other imaging pixel arrays having a plurality of photosensitive elements or pixels. An illumination system comprising light emitting diodes (LEDs) or other light source directs illumination toward a target object, e.g., a target bar code. Light reflected from the target bar code is focused through a lens of the imaging system onto the pixel array. Thus, an image of a field of view of the focusing lens is focused on the pixel array. Periodically, the pixels of the array are sequentially read out generating an analog signal representative of a captured image frame. The analog signal is amplified by a gain factor and the amplified analog signal is digitized by an analog-to-digital converter. Decoding circuitry of the imaging system processes the digitized signals and decodes the imaged bar code.

Existing two dimensional imaging scanners use image sensors such as sensors provided by Micron Technology Inc. A product specification entitled “½ Inch 1.3 Megapixel CMOS Active-Pixel Digital Image Sensor” (copyright, 2003) describes part no. MT9M001 and is incorporated herein by reference. Such sensors produce an electronic image of the focused light from a target such as a label. Prior art sensors include a set of programmable registers that can store one sensor configuration for a specific operation. Common registers include bits that set the exposure time (length of time over which the image is collected), electronic gain, row start, column start, row sizes and column size. The row and column start and size are used to specify the rectangular region of interest to be read from the 2D sensor array. For example, a 640×480 sensor has 640 columns and 480 rows. The sensor can be configured to start reading at column 50, row 100 and read 200 columns and 300 rows. This would produce an image size of 200×300 (60,000 pixels) that start with pixel 50, 100 of the array.

An image sensor operating in video mode with only a single set of configuration registers produces a sequence of images sharing one configuration. If multiple configurations are desired, then the configuration registers must be reprogrammed during an image capture sequence and there is typically one or more frame delays before an image with the updated configuration is produced. This presents a synchronization issue because the timing of the register updates may be difficult to predict.

Automatic exposure control (AEC) is used in a 2D imager for determining the proper exposure time to collect an image with good contrast. To perform AEC with a prior art system, an image is acquired, analyzed and the configuration is updated with an estimate of the best exposure. The system iterates until a good exposure is found.

### SUMMARY OF THE INVENTION

An exemplary system has an image sensor that includes multiple configuration registers. With multiple configuration registers a video mode can be implemented where the video consists of a continuous sequence of frames with a fixed sequence of a number of configurations. The configurations can vary the frame size, exposure time, gain, etc. Compared to a sensor with only one set of configuration registers, successive frames can be captured with different configurations without synchronization issues or frame lag.

An exemplary system for evaluating a target image includes an imaging and decoding system for capturing a sequence of target images at a frame rate from a target including focusing optics defining a field of view for focusing reflected illumination from an image. A sensor array defines an array of picture elements including a plurality of configuration memories for storing image capture configuration instructions. A processor has a memory for storing an image gathered from the sensor array from a target located within the field of view and programming the configuration memories.

These and other objects, advantages, and features of the exemplary system are described in detail in conjunction with the accompanying drawings.

### BRIEF DESCRIPTION OF THE DRAWINGS

FIG. 1 is a perspective view of a bar code scanner supported on a stationary stand;

FIG. 2 is a schematic sectional view of a portion of the imaging-based bar code reader showing the scanner head;

FIG. 3 is a block circuit diagram of the imaging-based bar code reader of FIG. 1;

FIG. 4 is a block diagram of an image sensor used with the exemplary system; and

FIG. 5 is a timing diagram showing capture of two successive image frames that are captured in timed relation to a target illumination as shown.

### DETAILED DESCRIPTION

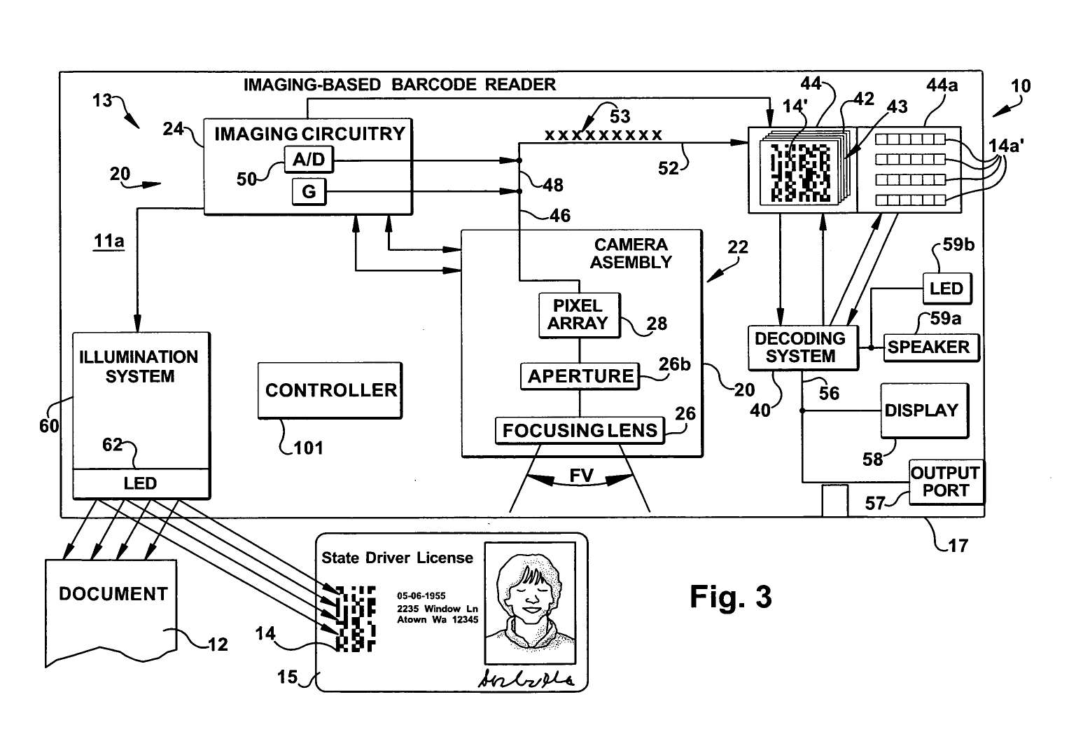

An imaging-based scanner or reader that is capable of reading bar codes is shown schematically at 10 in the Figures. One example of a 2D bar code 14 is shown in FIG. 3. Additionally, the reader 10 is also capable of capturing images such as an image of a document 12. The bar code reader 10 includes a housing 11 supporting an imaging system 20 and a decoding system 40 (FIG. 3). The housing 11 supports a transparent window 17 through which reflected illumination from the target document is received by the imaging system 20.

When enabled, the imaging system 20 captures an image frame 42 of a field of view FV of the imaging system which is stored in a memory 44. The imaging process captures an image of the target bar code. The decoding system 40 analyzes a captured image frame 42 and attempts to decode decodable portions of the image frame 42. The decoded portions of the image frame 42 are stored in a buffer memory 44a. Alternately, a series of image frames 43 are captured and using a stitching method the decoding system 40 attempts to combine or stitch the decoded portions stored in buffer memory to achieve a full decode of the document 12.

The imaging system 20 includes an imaging camera 22 (FIG. 2) and associated imaging circuitry 24. The imaging camera 22 includes a housing supporting focusing optics including a focusing lens 26 and a 2D photosensor or pixel array 28. The imaging camera 22 is coupled to a controller 101 and may be enabled during an imaging session to capture a sequence of images having different characteristics from the field of view FV of the focusing lens 26.

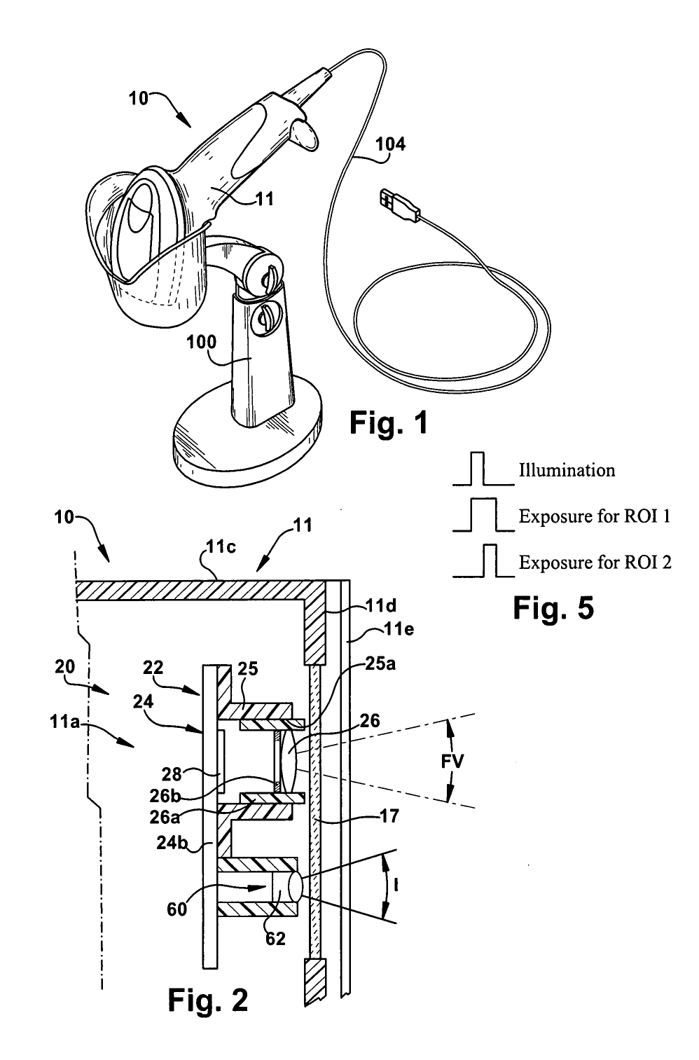

In one mode of operation, the bar code reader 10 is a hands-free reader including a housing having a flat base portion that can be placed on a counter or tabletop. The scanner 10 of FIG. 1 is supported by a support stand 100. When so mounted, the exposure operation mode of the camera can be altered to enhance the image quality of the resulting image produced by the scanner 10.

The housing 11 defines an interior region 11a. Disposed within the interior region are the imaging and decoding systems 20, 40 and an illumination assembly 60 including one or more light emitting diodes 62. When enabled, the LEDs 62 direct illumination through the transparent window 17 and onto a target. Circuitry 13 within the housing 11 is electrically coupled to a power supply, which may be in the form of an on-board battery or a connected off-board power supply. If powered by an on-board battery, the reader 10 may be a stand-alone, portable unit. If powered by an off-board power supply, the reader 10 may have some or all of the reader's functionality provided by a connected host device.

Circuitry associated with the imaging and decoding systems 20, 40, including the imaging circuitry 24, may be embodied in hardware, software, electrical circuitry or any combination thereof and may be disposed within, partially within, or external to the camera assembly housing 25. In the illustrated embodiment, the functions of the reader are controlled and co-ordinated by a microprocessor controller 101. The controller 101 also manages outputs from the decoding system 40 such as an output 56 to a display 58 and communications output port 57 (coupled to a cable 104) and visual and audible signals from an LED 59b and speaker 59a. The imaging camera housing 25 is supported with an upper or scanning head portion 11c of the housing and receives reflected illumination from the target document through the transparent window 17 supported by the scanning head 11c. The focusing lens 26 is supported by a lens holder 26a. The camera housing 25 defines a front opening 25a that supports and seals against the lens holder 26a so that the only illumination incident upon the sensor array 28 is illumination passing through the focusing lens 26.

Depending on the specifics of the camera assembly 22, the lens holder 26a may slide in and out within the camera housing front opening 25a to allow dual focusing under the control of the imaging circuitry 24 or the lens holder 26a may be fixed with respect to the camera housing 25 in a fixed focus camera assembly. The lens holder 26a is typically made of metal. A back end of the housing 25 may be comprised of a printed circuit board 24b, which forms part of the imaging circuitry 24 and may extend beyond the housing 25 to support the illumination system 60.

The imaging system 20 includes the sensor array 28 which may comprise a charged coupled device (CCD), a complementary metal oxide semiconductor (CMOS), or other imaging pixel array, operating under the control of the imaging circuitry 24. In one exemplary embodiment, the pixel array 28 comprises a two dimensional (2D) mega pixel array with a typical size of the pixel array being on the order of 1280×1024 pixels.

As is best seen in FIG. 2, the focusing lens 26 focuses light reflected from the target bar code 14 through an aperture 26b onto the pixel/photosensor array 28. Thus, the focusing lens 26 focuses an image of the target document within the field of view FV onto the array of pixels comprising the pixel array 28. The focusing lens 26 field of view FV includes both a horizontal and a vertical field of view, the vertical field of view being shown schematically as FV in FIG. 2.

During an imaging session, one or more images in the field of view FV of the reader 10 may be obtained by the imaging system 20. An imaging session may be instituted by an operator, for example, pressing a trigger to institute an imaging session. Alternately, the imaging system 20 may institute an imaging session when a lower or bottom edge of the item 15 moves through an upper portion of the field of view FV. Yet another alternative is to have the imaging system 30 always operational. In such a video mode image after image is captured and analyzed for the presence of data within an imaged target. In any event, the process of capturing an image 42 of the field of view FV during an imaging session is known in the scanner art.

Electrical signals are generated by reading out of some or all of the pixels of the pixel array 28 after an exposure period. After the exposure time has elapsed, some or all of the pixels of pixel array 28 are successively read out, thereby generating an analog signal 46. In some sensors, particularly CMOS sensors, all pixels of the pixel array 28 are not exposed at the same time, thus, reading out of some pixels may coincide in time with an exposure period for other pixels from a different part of the array 28.

The analog image signal 46 from the pixel array represents a sequence of photosensor voltage values, the magnitude of each value representing an intensity of the reflected light received by a photosensor/pixel during an exposure period. The analog signal 46 is amplified by a gain factor, generating an amplified analog signal 48. The imaging circuitry 24 further includes an analog-to-digital (A/D) converter 50. The amplified analog signal 48 is digitized by the A/D converter 50 generating a digitized signal 52. The digitized signal 52 comprises a sequence of digital gray scale values 53 typically ranging from 0-255 (for an eight bit processor, i.e., 2⁸=256), where a 0 gray scale value would represent an absence of any reflected light received by a pixel (characterized as low pixel brightness) and a 255 gray scale value would represent a very intense level of reflected light received by a pixel during an integration period (characterized as high pixel brightness).

### Frame Configurations

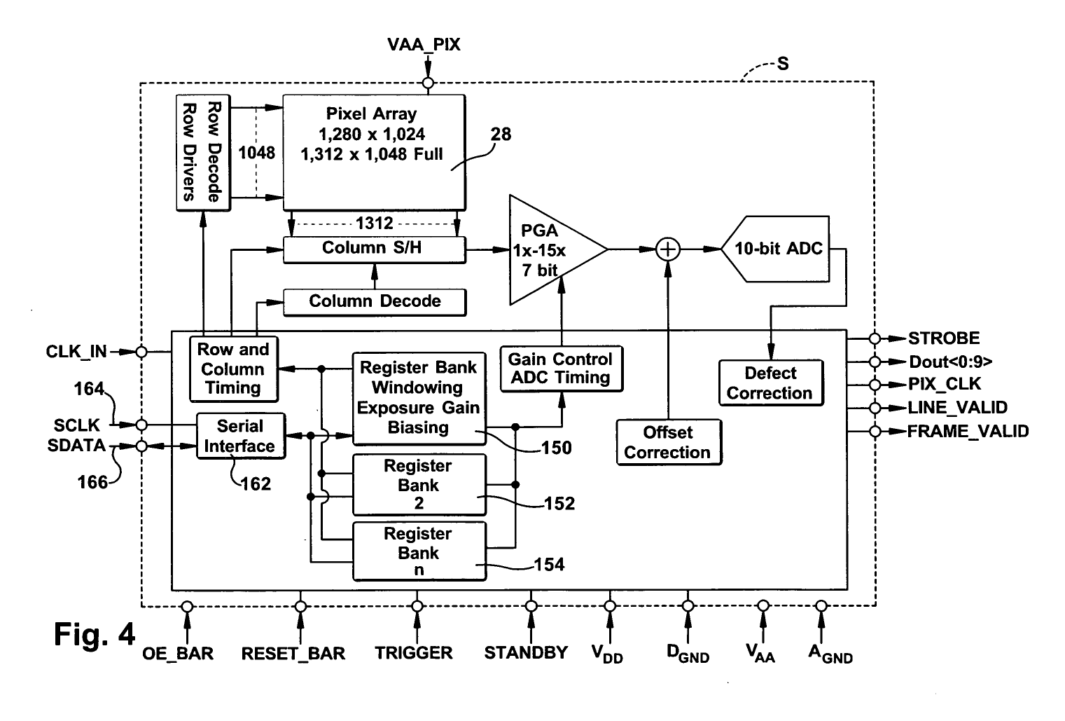

The imaging and decoding systems 20, 40 of the exemplary scanner 10 can capture a sequence of target images at a video frame rate from a target. The reader includes a sensor S (FIG. 4) that defines the array of picture elements 28 and includes a plurality of individually configurable memories or registers 150, 152, 154 for storing image capture configuration instructions.

As noted above, the sensor S responds to the controller 101 in configuring these registers or alternatively may include its own sensor controller. The memory 44 stores an image gathered from the sensor array from a target located within the field of view. The processor 101 executes a control program that updates the configuration memories for capturing images having different characteristics. Different image frames from the field of view are then captured at least as fast as the video frame rate of the imaging and decoding system.

With multiple configurations, the preferred embodiment of the system cycles through a sequence of exposures over a range and the information collected from multiple regions of interest (ROI) can be used, for example, to rapidly compute the best exposure. The same method can be used to adjust gain, or the gain/exposure can be adjusted concurrently. This has the effect of dramatically decreasing the automatic exposure control (AEC) response time.

In many cases, such as under normal office lighting conditions, a scanner requires the use of active illumination. It is highly desirable that whether illumination must be used be determined together with AEC. For determination of whether such illumination is required, a test flash from the LED 62 can be used on some parts of the image only. The test flash is timed such that it can be “seen” by some pixels on the sensor array, while cannot be seen by others. For example for many sensors the different pixels must finish their exposure at the same time. We can therefore provide timing signals such that pixels in different ROIs start their exposures at different times, but finish together. This is co-ordinated with an illumination pulse that occurs at the beginning of the longer exposure times, thus masking its influence on some pixels.

The timing diagram of FIG. 5 illustrates this use.. Here ROI 1 would expose with the illumination is on, and ROI2 with it off. If the ambient is dark and illumination is required, ROI 2 would be significantly under exposed, while ROI 1 may be properly exposed. To test for other conditions, more ROIs can be used with different gain values. For example, a third region of interest may be used with the same exposure timing as ROI 2, but with twice the gain.

Motion detection is sometimes used to determine the presence of an object to be scanned. Multiple regions of interest (ROI) are used to detect motion of an object into the field of view. The performance of this type of system is dramatically improved by programmed a sequence of ROI's into the sensor such that any delays or synchronization issues due to reprogramming are avoided.

Returning to FIG. 4, the sensor S includes a serial interface 162 through which the controller 101 programs the multiple banks of registers 150, 152, 154. Data is presented at an input 166 and this data is clocked into a buffer which is coupled to the three registers 150, 152, 154. Although three registers are depicted it is appreciated that more such registers can be utilized. The controller selects a given register using its binary address and then clocks the data from the serial interface 162 into the selected register. In this way different fields of view are programmed into the registers. In the exemplary embodiment when the trigger input to the sensor is activated the registers begin to grab frames starting with a frame whose region of interest is controlled by the first register 150. The sensor then cycles through the other registers for each subsequent frame.

The exposure time is programmed for each ROI. The read-out time is determined by the number of pixels in the ROI. The registers are programmed through a standard 2-wire serial interface known as 12C (I-squared C). A chip select is not needed because the 12C protocol requires that a device address precede any register read or write.

While the present invention has been described with a degree of particularity, it is the intent that the invention includes all modifications and alterations from the disclosed design falling within the spirit or scope of the appended claims.

1. Apparatus for evaluating bar codes contained in a target image comprising:
a) an imaging and decoding system for capturing a sequence of target images at a video frame rate from a target including focusing optics defining a field of view for focusing reflected illumination from the field of view;
b) a sensor including an array of picture elements and a plurality of configuration memories for storing image capture configuration instructions; and
c) a processor including a memory for storing an image gathered from the sensor array from a target located within the field of view and programming the configuration memories;
d) said processor executing a control program that updates the configuration memories to allow the sensor to capture images having different characteristics at least as fast as the frame rate of the imaging and decoding system.

2. The apparatus of claim 1 wherein the frame rate is at least 10 frames per second.

3. The apparatus of claim 1 wherein the sensor comprises a serial interface for individually configuring a specified configuration memory.

4. The apparatus of claim 1 wherein the processor programs the configuration memories to include multiple regions of interest to detect motion of an object within the field of view of the scanner.

5. A method of reading a target with an imaging based reader comprising:
a) providing an imaging and decoding system having an image sensor array for imaging a target and including focusing optics, the focusing optics defining a field of view for focusing reflected illumination from the target onto the image sensor array;
b) capturing a succession of image frames at a frame update rate of at least 10 frames per second and storing image data from the succession of image frames within a memory of the reader; and
c) between the capture of two consecutive image frames in said succession of image frames, reconfiguring the image sensor array by adjusting contents of a sensor configuration memory to adjust imaging characteristics of the reflected illumination from the target in two succession image frames within the reader's field of view.

6. The method of claim 5 wherein images from the succession of image frames are compared by a processor to optimize the image exposure for a next subsequent image.

7. The method of claim 5 wherein an exposure is optimized by illuminating a target, capturing a first region of interest as the target is illuminated and then capturing a second region of interest.

8. The method of claim 6 wherein different regions of interest are imaged in the successive image frames to detect motion of an object within the field of view.

9. The method of claim 6 wherein different signal gains are applied to different pixels of the sensor array.

10. (canceled)

11. Apparatus for reading a target comprising:
a) imaging means for imaging a target having multiple target bar codes, said imaging means including focusing optics defining a field of view and focusing reflected illumination from the target;
b) sensor means for processing signals from a sensor array for capturing light from the field of view and forming an image frame;
c) processor means including a memory for storing multiple image frames gathered from the sensor array and evaluating said image frames; and
d) configuration means for adjusting the image frame from successive image captures;
e) wherein the processor means updates the configuration means between two successive image captures within a sequence of image captures at a video capture rate of at least 20 frames per second to alter the image frame from the imaging means.

12. The apparatus of claim 11 wherein the processor means updates the configuration means prior to the capturing of successive images.

13. The apparatus of claim 11 wherein the configuration means comprises multiple registers that dictate outputs from the sensor means.

14. The apparatus of claim 13 wherein the configuration means comprises a serial interface for receiving configuration instructions from the processor means.

15. The apparatus of claim 14 wherein the processor means comprises a programmable controller having program instructions for communicating configuration instructions to the configuration means through the serial interface.

16. Apparatus for evaluating a target image comprising:
a) an imaging and decoding system for capturing a sequence of target images at a video frame rate of at least 20 frames per second from a target including focusing optics defining a field of view for focusing reflected illumination from an image;
b) a sensor defining a sensor array of picture elements for capturing light from the target and producing an analog output, said sensor including a plurality of configuration memories for storing image capture configuration instructions;
c) a control for programming the configuration memories between two successive image captures from picture elements of the sensor array from two different regions of interest within the field of view; and
d) a memory for storing an image gathered from the sensor array from a target located within the field of view.

17. The apparatus of claim 16 including a light source and wherein the control co-ordinates activation of the light source with capture of target images from the two regions of interest.

18. (canceled)

19. The apparatus of claim 16 wherein the sensor comprises a serial interface for programming the configuration memories wherein an address for a particular configuration memory is included in serial data at the serial interface.

20. The apparatus of claim 19 wherein the control comprises a programmable controller for formatting and transmitting a serial sequence of data to the sensor to configure the configuration memories and then subsequently initiating capture of a sequence of target images by the imaging and decoding system.
